(19) United States
(12) Patent Application Publication
(10) Pub. No.: US 2008/0094781 A1
(43) Pub. Date: Apr. 24, 2008

(54) Electrode Sheet for Capacitors, Method of Manufacturing the Same, and Electrolytic Capacitor

(75) Inventors: Atsushi Otaki, Tochigi (JP); Takenori Hashimoto, Tochigi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SHOWA DENKO K.K., TOKYO (JP)

(21) Appl. No.: 11/576,752

(22) PCT Filed: Oct. 7, 2005
(86) PCT No.: PCT/JP05/18911

§ 371 Date: Apr. 5, 2007

Related U.S. Application Data
(60) Provisional application No. 60/619,031, filed on Oct. 18, 2004.

(30) Foreign Application Priority Data
Oct. 8, 2004 (JP) 2004-296366

(51) Int. Cl. H01G 9/045; C23C 4/08

(52) U.S. Cl. 361/528; 427/456

(57) ABSTRACT

A method of manufacturing an electrode sheet for capacitors comprises the step of forming a sprayed layer of an Al-valve action metal alloy on at least one surface of an aluminum foil (2) by thermally spraying Al-valve action metal alloy powder on the surface of the aluminum foil. At the time of the spraying, a porosity content rate of the sprayed layer (3) is controlled to 20 vol % or less by melting at least a matrix Al phase of the alloy. The electrode sheet for capacitors manufactured by the method can decrease the porosity content rate of the sprayed layer, which in turn can secure less leakage current and larger capacitance.

This application claims priority to Japanese Patent Application No. 2004-296366 filed on Oct. 8, 2004 and U.S. Provisional Application Ser. No. 60/619,031 filed on Oct. 18, 2004, the entire disclosures of which are incorporated herein by reference in their entireties.

### CROSS REFERENCE TO RELATED APPLICATIONS

This application is an application filed under 35 U.S.C. §111(a) claiming the benefit pursuant to 35 U.S.C. §119(e)(1) of the filing date of U.S. Provisional Application Ser. No. 60/619,031 filed on Oct. 18, 2004, pursuant to 35 U.S.C. §111(b).

### TECHNICAL FIELD

The present invention relates to an electrode sheet for capacitors capable of attaining large capacitance and less leakage current, a method of manufacturing the electrode sheet, and an electrolytic capacitor.

In this disclosure including claims, the wording of “aluminum” is used to include the meaning of its alloy. Furthermore, in the disclosure, the wording of “Al” denotes aluminum (metal simple substance).

### BACKGROUND ART

The following description sets forth the inventor's knowledge of related art and problems therein and should not be construed as an admission of knowledge in the prior art.

In accordance with the recent digitalization of electric equipments, electrolytic capacitors have been demanded to be small in size and large in capacitance. Among other things, in communication facilities such as personal computers and cellular phones, in accordance with the increased operation speed of CPUs mounted therein, it has been strongly demanded to further increase capacitance of capacitors.

Known as an electrode foil for capacitors capable of securing large capacitance is an electrode foil manufactured by forming an alloy foil of valve action metal (valve metal) such as Ti and Zr and aluminum by a rapid solidification method, etching this alloy foil, and then anodizing the alloy foil to form an oxide film on the surface thereof (see Japanese Unexamined Laid-open Patent Publication No. S60-66806, especially see the claims and the right lower column on page two thereof).

However, an aluminum alloy foil manufactured by such a rapid solidification method was insufficient in strength, especially low in bending strength and therefore poor in bending durability. In recent years, in most electrolytic capacitors, a structure in which electrode foils are wound is employed in view of the demand of miniaturization. However, in the aforementioned conventional aluminum alloy foil (obtained by a rapid solidification method), since the foil is easily broken at the time of the winding, it cannot be put into practical use at all.

Furthermore, as an electrode foil for capacitors capable of securing large capacitance, also known is an electrode foil in which intermetallic compound of Al-valve action metal is finely dispersed in Al (Japanese Unexamined Laid-open Patent Publication No. H01-124212, especially see the claims). In this electrode capacitor, although capacitance can be increased, sufficient strength cannot be obtained since the intermetallic compound is precipitated in the Al. Especially, it was low in bending strength and poor in bending durability.

Under the circumstances, as an electrode material for electrolytic capacitors, it has been proposed to use an electrode foil manufactured by thermally spraying powder of an aluminum alloy (e.g., Al—Zr alloy, Al—Ti alloy) containing valve action metal such as Zr or Ti onto a surface of an aluminum foil, then subjecting the aluminum foil to sintering or rolling in an inert atmosphere to thereby form a porous coating layer on the surface of the aluminum foil (see Japanese Unexamined Laid-open Patent Publication No. H2-91918, especially see the claims). This electrode foil can attain large capacitance and high bending strength, thus excellent bending durability. Accordingly, it can be applied to wound type electrolytic capacitors.

However, the sprayed layer formed by thermally spraying Al-valve action metal alloy powder has numerous porosities (e.g., pores, hollows) and an oxide film is formed on the surface of the porosities, which increases leakage current. Although the porosity can be crashed by, e.g. rolling, even if the porosity is crashed by the rolling, the oxide film once formed on the porosity remains in the sprayed layer in an involved state. As a result, leakage current cannot be decreased by the rolling processing.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

Other objects and advantages of the present invention will be apparent from the following preferred embodiments.

### DISCLOSURE OF INVENTION

The preferred embodiments of the present invention have been developed in view of the above-mentioned and/or other problems in the related art. The preferred embodiments of the present invention can significantly improve upon existing methods and/or apparatuses.

The present invention has been completed based on the inventor's findings that the porosity content rate of the sprayed layer can be decreased by specific thermal spraying conditions and that less leakage current and larger capacitance can be secured when the porosity content rate of the sprayed layer is 20 vol % or less.

To attain the aforementioned objects, the present invention provides the following structure.

[1] A method of manufacturing an electrode sheet for capacitors, comprising the step of:

forming a sprayed layer of an Al-valve action metal alloy on at least one surface of an aluminum foil by thermally spraying Al-valve action metal alloy powder on the surface of the aluminum foil,

wherein a porosity content rate of the sprayed layer is controlled to 20 vol % or less by melting at least a matrix Al phase of the alloy at the time of the spraying.

[2] A method of manufacturing an electrode sheet for capacitors, comprising the step of:

forming a sprayed layer of an Al-valve action metal alloy on at least one surface of an aluminum foil by thermally spraying Al-valve action metal alloy powder on the surface of the aluminum foil,

wherein a porosity content rate of the sprayed layer is controlled to 12 vol % or less by melting a matrix Al phase of the alloy with intermetallic compound of the Al-valve action metal which is high-melting point precipitate of the alloy unmelted at the time of the spraying.

[3] A method of manufacturing an electrode sheet for capacitors, comprising the step of:

forming a sprayed layer of an Al-valve action metal alloy on at least one surface of an aluminum foil by thermally spraying Al-valve action metal alloy powder on the surface of the aluminum foil,

wherein the Al-valve action metal alloy powder is 5 to 500 μm in particle diameter, and wherein the spraying is performed with thermal spraying heat quantity set to 3 to 7 kJ/l.

[4] The method of manufacturing an electrode sheet for capacitors as recited in the aforementioned Item 3, wherein the Al-valve action metal alloy powder is 5 to 95 vol % in alpha phase content rate.

[5] The method of manufacturing an electrode sheet for capacitors as recited in any one of the aforementioned Items 1 to 4, wherein the aluminum foil is 8 to 200 μm in thickness.

[6] The method of manufacturing an electrode sheet for capacitors as recited in any one of the aforementioned Items 1 to 5, further comprising the step of:

performing ultrasonic cleaning after the step of forming the sprayed layer of the Al-valve action metal alloy.

[7] The method of manufacturing an electrode sheet for capacitors as recited in any one of the aforementioned Items 1 to 6, further comprising the step of:

performing rolling and annealing after the step of forming the sprayed layer of the Al-valve action metal alloy.

[8] The method of manufacturing an electrode sheet for capacitors as recited in any one of the aforementioned Items 1 to 7, further comprising the step of:

performing acid cleaning or alkali cleaning after the step of forming the sprayed layer of the Al-valve action metal alloy.

[9] The method of manufacturing an electrode sheet for capacitors as recited in any one of the aforementioned Items 1 to 8, wherein the Al-valve action metal alloy powder is alloy powder including one or more valve action metals selected from the group consisting of Ti, Zr, Nb, Ta and Hf, and Al.

[10] The method of manufacturing an electrode sheet for capacitors as recited in any one of the aforementioned Items 1 to 9, wherein the Al-valve action metal alloy powder is Al—Zr alloy powder.

[11] An electrode sheet for capacitors manufactured by the method as recited in any one of the aforementioned Items 1 to 10.

[12] A method of manufacturing an anode material for electrolytic capacitors, comprising the steps of:

etching the electrode sheet for capacitors as recited in the aforementioned Item 11; and thereafter

executing a chemical conversion treatment to thereby form a dielectric film on a surface of the etched electrode sheet.

[13] An anode material for electrolytic capacitors manufactured by the manufacturing method as recited in the aforementioned Item 12.

[14] An electrolytic capacitor constituted by using the anode material as recited in the aforementioned Item 13.

According to the invention as recited in the aforementioned Item [1], since the spraying is performed in a state in which at least the matrix Al phase of the alloy (Al-valve action metal alloy) is melted, the porosity content rate of the formed sprayed layer can be controlled to 20 vol % or less. Therefore, the obtained electrode sheet can secure less leakage current and large capacitance.

According to the invention as recited in the aforementioned Item [2], the spraying is performed in a state in which the intermetallic compound of the Al-valve action metal which is high-melting point precipitate is unmelted and the Al phase which is a matrix of the alloy is melted at the time of the spraying. In other words, the spraying is performed at a low power in which the intermetallic compound of the Al-valve action metal which is high-melting point precipitate cannot melt but the matrix Al phase can melt. Accordingly, the porosity content rate of the formed sprayed layer can be controlled to 12 vol % or less. Therefore, the obtained electrode sheet can secure less leakage current and large capacitance.

According to the invention as recited in the aforementioned Item [3], the spraying is performed using the Al-valve action metal alloy powder 5 to 500 μm in particle diameter in a state in which thermal spraying heat quantity is set to 3 to 7 kJ/l which is a low power output. Therefore, the spraying can be performed in a state in which at least the matrix Al phase of the alloy (Al-valve action metal alloy) is melted (i.e., without causing evaporation), which makes it possible to control the porosity content rate of the formed sprayed layer to 20 vol % or less. Accordingly, the obtained electrode sheet can secure less leakage current and large capacitance. Furthermore, since the spraying heat quantity is 3 to 7 kJ/l which is a low output, the heat at the time of the spraying does not cause any crinkles of the aluminum foil as a core member due to elongation which may be caused by heat.

According to the invention as recited in the aforementioned Item [4], since the Al-valve action metal alloy 5 to 95 vol % in alpha phase content rate is used, the composition can be changed, which makes it possible to adjust the capacitance.

According to the invention as recited in the aforementioned Item [5], since the aluminum foil 8 to 200 μm in thickness is used, the heat at the time of the spraying does not cause meltdown of the foil, resulting in large capacitance.

According to the invention as recited in the aforementioned Item [6], since the electrode sheet in which the sprayed layer of Al-valve action metal alloy is formed on the aluminum foil is subjected to ultrasonic cleaning, unstably deposited portions in the sprayed layer 3 before the etching treatment can be removed, which makes it possible to form favorable etched structure after the etching treatment.

According to the invention as recited in the aforementioned Item [7], the electrode sheet in which the sprayed layer of Al-valve action metal alloy is formed on the aluminum foil is rolled and annealed. The rolling and annealing steps enable disappearance of minute porosity existed in the sprayed layer, which makes it possible to manufacture an electrode sheet with less leakage current. It is preferable that the rolling step and the annealing step are performed at least one time respectively.

According to the invention as recited in the aforementioned Item [8], the electrode sheet in which the sprayed layer of Al-valve action metal alloy is formed on the aluminum foil is subjected to acid cleaning or alkali cleaning. This acid cleaning step or alkali cleaning step enables sufficient removal of unstably deposited portions in the sprayed layer before the etching step, which in turn makes it possible to form favorable etched structure after the etching treatment.

According to the invention as recited in the aforementioned Item [9], an electrode sheet with larger capacitance can be manufactured.

According to the invention as recited in the aforementioned Item [10], an electrode sheet with further increased capacitance can be manufactured.

According to the electrode sheet for capacitors according to the present invention as recited in the aforementioned Item [1,1], leakage current can be decreased, and large capacitance can be obtained.

According to the invention as recited in the aforementioned Item [1,2], the surface area of the spayed layer can be increased by the etching treatment and a dielectric film with large dielectric constant can be formed by the chemical conversion treatment. Therefore, an electrolytic capacitor further improved in capacitance can be provided.

The anode material according to the invention as recited in the aforementioned Item [13] is small in leakage current and can attain larger capacitance. Accordingly, using of the anode material makes it possible to provide a wound type electrolytic capacitor small in size, large in capacitance and small in leakage current.

In the invention as recited in the aforementioned Item [14], since it is constituted by using the anode material as recited in the aforementioned Item [13], an electrolytic capacitor small in size, large in capacitance and small in leakage current can be provided.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF DRAWINGS

The preferred embodiments of the present invention are shown by way of example, and not limitation, in the accompanying figures, in which:

FIG. 1 is a cross-sectional view showing an electrode sheet for capacitors according to an embodiment of this invention;

FIG. 2 is a scanning electron microscope (SEM) photograph showing a cross-section of the electrode sheet (before rolling) of Example 2;

FIG. 3 is an enlarged SEM photograph showing the sprayed layer of the rolled electrode sheet of Example 2;

FIG. 4 is a scanning electron microscope (SEM) photograph showing a cross-section of the electrode sheet (before rolling) of Comparative Example 2; and

FIG. 5 is an enlarged SEM photograph showing the sprayed layer of the rolled electrode sheet of Comparative Example 2.

### BEST MODE FOR CARRYING OUT THE INVENTION

In the following paragraphs, some preferred embodiments of the invention will be described by way of example and not limitation. It should be understood based on this disclosure that various other modifications can be made by those in the art based on these illustrated embodiments.

A preferable embodiment of the present invention will be explained with reference to the attached drawings. In a method of manufacturing an electrode sheet 1 for capacitors according to a preferable embodiment of the present invention, in forming a sprayed layer of Al-valve action metal alloy on at least one surface of an aluminum foil 2 by thermally spraying Al-valve action metal alloy powder on the surface of the aluminum foil 2, the porosity content rate of the sprayed layer 3 is controlled to 20 vol % or less by thermally spraying the alloy with at least the matrix Al phase thereof melted.

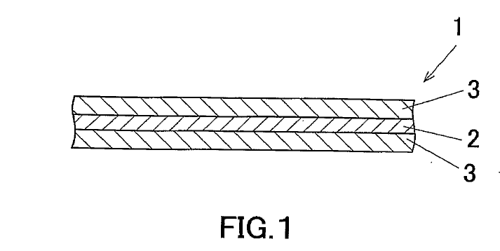

According to this manufacturing method, at the time of thermally spraying Al-valve action metal alloy powder on the surface of the aluminum foil 2, the spraying is performed in a state in which at least the matrix Al phase of the alloy (Al-valve action metal alloy) is melted. Therefore, the formed sprayed layer 3 can take compact structure, which enables the porosity content rate of the sprayed layer 3 to be controlled to 20 vol % or less. Since the porosity content rate of the sprayed layer can be controlled to 20 vol % or less, the obtained electrode sheet 1 can secure less leakage current and larger capacitance. For example, when the alloy powder is sprayed on both surfaces of the aluminum foil 2, an electrode sheet 1 in which sprayed layers 3 and 3 of Al-valve action metal alloy are laminated on both surfaces of a core member 2 can be obtained as shown in FIG. 1. Furthermore, since the alloy layer 3 of Al-valve action metal is formed by the thermal spraying, the obtained electrode sheet 1 is excellent in bending durability. Accordingly, it can be applied to wound type electrolytic capacitors.

Among other things, in forming the sprayed layer 3 of Al-valve action metal alloy on at least one surface of the aluminum foil 2 by thermally spraying Al-valve action metal alloy powder on the surface of the aluminum foil 2, it is preferable that the porosity content rate of the sprayed layer 3 is controlled to 12 vol % or less by melting the Al phase which is a matrix of the alloy with the intermetallic compound of Al-valve action metal which is a high-melting point precipitate unmelted at the time of the thermal spraying. According to this manufacturing method, since the thermal spraying is performed in a state in which the intermetallic compound of Al-valve action metal which is high-melting point precipitate is unmelted and the Al phase which is a matrix of the alloy is melted, it is possible to control the porosity content rate of the sprayed layer 3 to 12 vol % or less. It is more preferable that the porosity content rate of the sprayed layer 3 is controlled to 8 vol % or less.

If the porosity content rate of the sprayed layer 3 exceeds 20 vol %, the existence of a large amount of the oxide film to be formed on the porosity surface increases leakage current extremely and decreases capacitance.

The aforementioned thermal spraying to be performed in a state in which at least the matrix Al phase of the alloy (Al-valve action metal alloy) is melted at the time of thermally spraying the Al-valve action metal alloy powder on the surface of the aluminum foil 2 can be performed by using the Al-valve action metal alloy powder 5 to 500 μm in particle diameter with the spraying heat quantity set to 3 to 7 kJ/l.

It is preferable that the particle diameter of the Al-valve action metal alloy powder used for the spraying is 5 to 500 μm. If it is less than 5 μm, the metallic compound of the Al-valve action metal which is high-melting point precipitate will melt even at a low output spaying, resulting in an increased porosity content rate. On the other hand, if it exceeds 500 μm, the porosity content rate of the sprayed layer 3 increases, resulting in increased leakage current. Among other things, the particle diameter of the Al-valve action metal alloy is preferably 8 to 200 μm, more preferably 10 to 75 μm. As the powder (Al-valve action metal alloy powder) 5 to 500 μm in particle diameter, powder (Al-valve action metal alloy powder) with an average diameter of 50 μm and a particle diameter distribution range of 10 to 80 μm can be exemplified.

Furthermore, the spraying heat quantity at the time of the) thermal spraying is preferably set to 3 to 7 kJ/l. If it is less than 3 kJ/l, the forming rate of the sprayed layer 3 deteriorates remarkably. On the other hand, if it exceeds 7 kJ/l, the spraying output is excessively large, causing evaporation of the Al phase during the spraying. This results in an increased porosity content rate of the sprayed layer and a rich heterogenous phase in the valve-action metal, which in turn decreases capacitance by the heterogenous phase in cases where the porosity content rate becomes 50 volt or above. Among other things, it is especially preferable to set the spraying heat quantity at the time of the spraying to 4 to 6 kJ/l. In this disclosure, the “heterogenous phase (Zr rich phase)” is defined as a phase which contains supersaturated Zr and looks different from alpha phase through SEM observation. The distribution and the quantity of the heterogenous phase can be obtained by the same method as a method of calculating an alpha phase contain rate which will be detailed later. The “rich heterogenous phase” denotes a phase which exceeds the solid solubility limit and includes no crystal of intermetallic compound.

The spraying heat quantity can be adjusted by changing, e.g., the ratio of spraying current and/or spraying mixed gas (hydrogen, nitrogen, argon, etc.). The spraying heat quantity is a value (heat quantity) obtained by the product of the gas dissociation voltage and the gas spraying current. The gas dissociation voltage differs depending on gas type.

As the Al-valve action metal alloy powder, it is preferable to use alloy powder 5 to 95 vol % in alpha phase content rate. If the alpha content rate is less than 5 vol %, capacitance increase effects deteriorate, and therefore it is not preferable. On the other hand, if it exceeds 95 vol %, bending strength deteriorates, causing an easy breakage, and therefore it is not preferable. Among other things, it is preferable to use alloy powder 10 to 70 vol % in alpha phase content rate, more preferably alloy powder 20 to 60 vol % in alpha phase content rate. The aforementioned alpha phase content rate can be obtained by observing the composition image with an electron scanning microscope (SEM), performing image processing of the image to thereby calculate the area of the precipitated phase and then subtracting the area of the precipitated phase from the entire area.

As a method for the spraying, any known spraying method can be employed. For example, frame spraying, arc spraying, plasma spraying and cold spraying can be exemplified, through not limited thereto.

When gas, such as argon gas or helium gas, is introduced into a space between electrodes and the electrodes are discharged therebetween, ionized high temperature and high speed plasma will be generated. The aforementioned plasma spraying method is a method using such plasma as a heat source. In this method, spraying material powder is supplied in a high temperature and high speed plasma flow (plasma jet) to heat and accelerate the powder, so that the heated and accelerated powder is collided against a substrate.

In the aforementioned cold spraying method, high-pressure gas heated to a temperature lower than the melting point or softening temperature of the thermally spraying material is made into a supersonic flow, and thermally spraying material powder is supplied in the supersonic flow, so that the powder is collided against a substrate in the solid phase state.

It is well known in the technical field of this invention that valve-action metal forming an alloy with Al can be any one of Ti, Zr, Nb, Ta, Hf, etc., or any combination thereof and the addition of one or more elements causes an effect on the improvement of capacitance, as disclosed in, for example, Japanese Unexamined Laid-open Patent Publication Nos. S60-66806 and H01-124212 and H02-91918. Accordingly, in the manufacturing method of this invention, it is preferable to use alloy powder including one or more valve-action metals selected from the group consisting of Ti, Zr, Nb, Ta and Hf, and Al, as the aforementioned Al-valve action metal alloy powder. In this case, it is possible to manufacture an electrode sheet 1 having larger capacitance. Among other things, it is more preferable to use Al—Zr alloy powder as the Al-valve action metal alloy powder.

Furthermore, as the aluminum foil 2, it is preferable to use an Al foil, or an alloy foil including one or more valve-action metals selected from the group consisting of Ti, Zr, Nb, Ta and Hf, and Al. In this case, the obtained electrode sheet causes less film defect when the sheet is subjected to a chemical conversion treatment, resulting in further decreased leakage current.

Furthermore, as the aluminum foil 2, it is preferable that the thickness thereof is 8 to 200 μm. If it is less than 8 μm, there is concern that the aluminum foil is melted down by the spraying heat. Furthermore, rigidity as an electrode sheet 1 becomes insufficient, which in turn may easily cause cracks when the electrode sheet 1 is bent or cut. Therefore, it is not preferable. On the other hand, if it exceeds 200 μm, in cases where the electrode sheet 1 is accommodated in a casing in the wound state, the curvature radius R becomes large in the wound state, which makes it difficult to accommodate it in a casing and therefore the thickness of the spayed layer 3 should be decreased, resulting in insufficient capacitance. Thus, it is not preferable. Among other things, it is more preferable that the thickness of the aluminum foil 2 is 40 to 100 μm.

In the manufacturing method of this invention, It is preferable to add an ultrasonic cleaning step after the step of laminating the sprayed layer 3 of the Al-valve action metal alloy on the aluminum foil 2. This ultrasonic cleaning step enables removal of unstably deposited portions in the sprayed layer 3 before the etching treatment, which makes it possible to form favorable etched structure after the etching treatment. Although it is inevitable to avoid adhesion of spraying powder as raw materials to the sprayed layer 3, in the case of omitting the ultrasonic cleaning step, etching will be executed with the raw materials adhered. This causes rapid contamination of the etching liquid, which makes it difficult to perform stable etching. Furthermore, the unstably deposited portions of the sprayed layer 3 may exfoliate, generating large pits, which in turn makes it difficult to perform favorable etching. Accordingly, it is preferable to provide the aforementioned ultrasonic cleaning step.

As the cleaning liquid for use in the ultrasonic cleaning, acetone, methanol and ethanol can be exemplified, through not specifically limited thereto.

Furthermore, in the manufacturing method of this invention, it is preferable to add rolling and annealing steps after the step of laminating the sprayed layer 3 of the Al-valve action metal alloy on the aluminum foil 2. The rolling and annealing steps enable disappearance of minute porosity existed in the sprayed layer 3, which makes it possible to manufacture an electrode sheet 1 with less leakage current. The annealing step can be performed between the laminating step and the rolling step, after the rolling step, or before and after the rolling step after performing the laminating step. In other words, in cases where rolling and annealing steps are performed, the rolling and annealing steps can be performed in any order so long as each step is performed at least one time respectively.

It is preferable that the rolling reduction at the time of the rolling step is set to 1 to 50%. If it is less than 1%, it becomes difficult to obtain surface smoothening effects, and therefore it is not preferable. On the other hand, if it exceeds 50%, it is not preferable because the ductility of the sheet deteriorates remarkably. Among other things, it is more preferable that the rolling reduction is set to 5 to 30%.

Furthermore, in the manufacturing method of this invention, after the step of laminating the spraying layer of the Al-valve action metal alloy on the aluminum foil 2, an acid cleaning step or an alkali cleaning step can be performed. Such an acid cleaning step or an alkali cleaning step enables sufficient removal of unstably deposited portions of the sprayed layer 3 before the etching step, which in turn makes it possible to form favorable etched structure after the etching treatment.

As the acid for use in the acid cleaning, nitric acid aqueous solution can be exemplified, though not limited thereto. Furthermore, as the alkali for use in the alkali cleaning, sodium hydrate aqueous solution can be exemplified, though not limited thereto.

In the electrode sheet 1 manufactured by the manufacturing method of this invention, the thickness of the sprayed layer 3 is preferably 5 to 150 μm. If it is 5 μm, the core 2 of the aluminum foil may be exposed at the time of the etching processing, resulting in insufficient capacitance. Therefore, it is not preferable. On the other hand, if it exceeds 150 μm, electrolyte cannot be entered in the entire etched layer, resulting in insufficient capacitance. Therefore, it is also not preferable. Among other things, it is more preferable that the thickness of the sprayed layer 3 is 20 to 120 μm, especially 50 to 100 μm. In cases where rolling, annealing and/or other processing are performed, the aforementioned thickness of the sprayed layer 3 means a thickness of a sprayed layer after such processing.

Thus, an electrode sheet 1 which can be preferably used as an anode member for electrolytic capacitors can be manufactured by etching the electrode sheet 1 manufactured in accordance with the manufacturing method of this invention and then subjecting it to a chemical conversion treatment to thereby electrochemically form a dielectric film on the surface of the electrode sheet.

As the etching treatment, an etching method in which direct-current electricity is applied in a hydrochloric acid solution or an aluminum sulfate solution can be exemplified, though not limited thereto.

As the chemical conversion treatment, a chemical conversion treatment to be executed in a boric acid solution, a phosphoric acid solution, or an adipic acid solution can be exemplified, though not limited thereto.

The electrolytic capacitor according to the present invention is constituted by using the aforementioned anode member. Accordingly, it is possible to provide an electrolytic capacitor which is small in size, large in capacitance and small in leakage current.

Next, concrete examples of this invention will be explained. However, it should be noted that the present invention is not limited to them.

### EXAMPLE 1

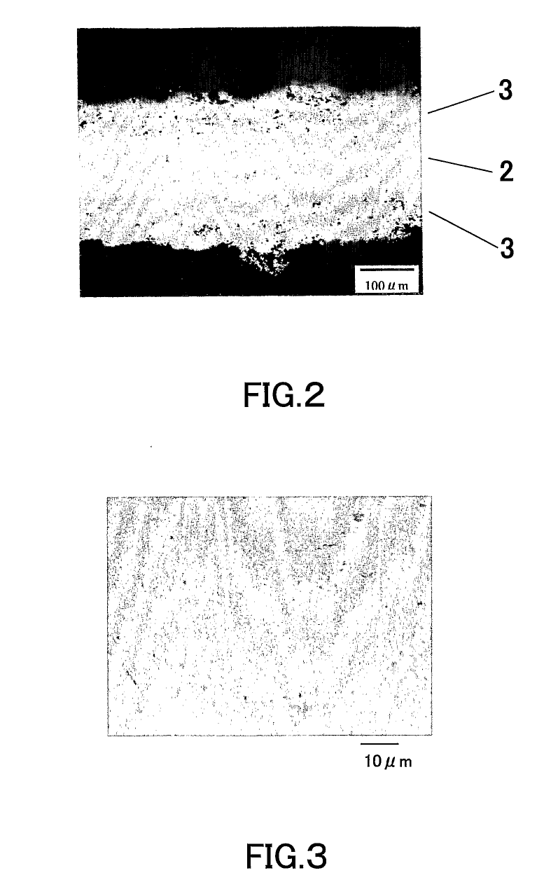

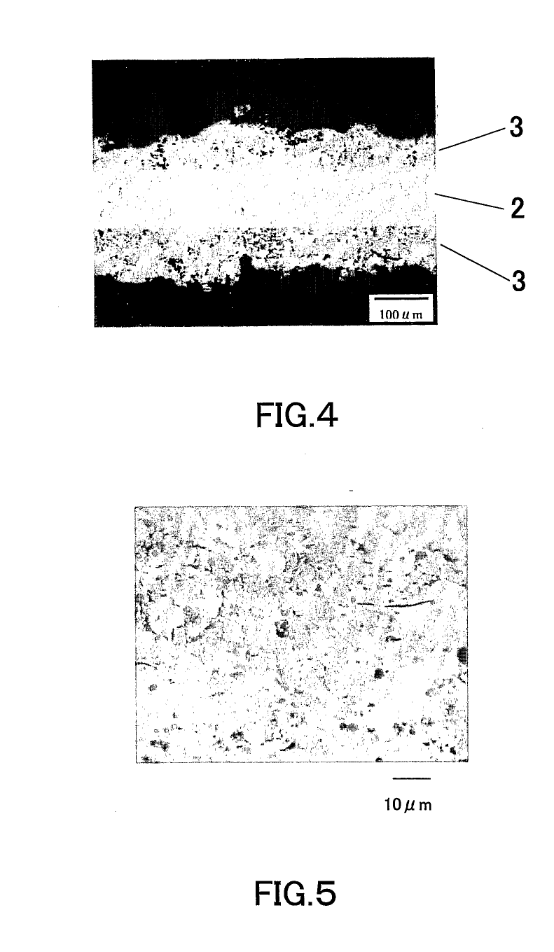

An electrode sheet 1 as shown in FIG. 1 was obtained by arc-spraying (spraying thermal quantity: 5 kJ/l) Al—Zr alloy (Al: 73 wt %, Zr: 27 wt %) powder (particle diameter: 15 to 150 μm) on both surfaces of a 50 μm-thick aluminum foil core 2 with the purity of 99.9% or above (Si: 30 ppm, Fe: 15 ppm, Cu: 40 ppm) to form a 120 μm-thick sprayed layer 3 on each of the surfaces of the core 2. The alpha phase content rate of the Al—Zr alloy powder was 40%. The spraying current was 180 A, the spraying mixed gas flow was 250 L/min., the ratio of the spraying mixed gas was hydrogen: nitrogen: argon=10:10:80 (vol %). The scanning electron micrograph showing the cross-section of the obtained electrode sheet is shown in FIG. 2. The porosity content rate of the sprayed layer 3 was 3 vol %.

The electrode sheet was immersed in 3% (mass %)-H₃PO₄ solution and boiled for 120 seconds at 90° C. to degrees, then washed with running water, and further subjected to ultrasonic cleaning in acetone solvent.

Furthermore, the electrode sheet was immersed in 3% (mass %)-nitric acid solution for 3 minutes to execute acid cleaning, and then dried for 5 minutes at 50° C.

Next, the dried electrode sheet was rolled at the rolling reduction of 20% by passing between a pair of reduction rolls, and then subjected to heat treatment (annealing) for 5 minutes at 500° C. in the air.

Thereafter, the sheet was subjected to etching treatment. The etching treatment was performed under the condition that the etching liquid was HCl (1 mol/L+H₂SO₄ (3.5 mol/L) solution, the temperature was 75° C., and the current density DC was 0.5 A/cm² (one surface).

Furthermore, constant voltage chemical conversion treatment of 20 V×10 minutes at the current density of 5 mA/cm² was executed in ammonium phosphate solution (concentration of 1.5 g/L, 85° C.).

Then, heat treatment (annealing) was performed for 5 minutes at 500° C. in the air, and thereafter chemical conversion treatment was again performed in the same condition as the aforementioned chemical conversion treatment (except that the constant voltage chemical conversion treatment time was 5 minutes) to thereby obtain an electrode sheet.

### EXAMPLES 2, 3, AND COMPARATIVE EXAMPLES 1 AND 2

In each of these examples, an electrode sheet was obtained in the same manner as in Example 1, except that spraying was performed by setting the spraying heat quantity at the time of spraying Al—Zr alloy powder to the value shown in Table 1.

TABLE 1

| | Alloy powder | | | | | | | | | | |
|---|---|---|---|---|---|---|---|---|---|---|---|
| | | | alpha | | | | | Porosity | | CV product | LC value |
| | | | phase | Spraying | | | | content rate | Heterogenous | index (when | Leakage |
| | | Particle | content | heat | Ultrasonic | Acid | | of sprayed | phase (Zr rich | Comparative | current |
| | | diameter | rate | quantity | cleaning | cleaning | Reduction | layer | layer) rate | Example 2 | amount |
| | Type | (μm) | (%) | (kJ/l) | treatment | treatment | treatment | (vol %) | (vol %) | is 100) | (μm) |
| Comp. | Al—Zr | 15-150 | 40 | 2.7 | Yes | Yes | Yes | 47 | 6 | 73 | 12 |
| Ex. 1 | | | | | | | | | | | |
| Ex. 1 | Al—Zr | 15-150 | 40 | 4 | Yes | Yes | Yes | 20 | 13 | 119 | 26 |
| Ex. 2 | Al—Zr | 15-150 | 40 | 5 | Yes | Yes | Yes | 3 | 20 | 154 | 15 |
| Ex. 3 | Al—Zr | 15-150 | 40 | 6 | Yes | Yes | Yes | 12 | 49 | 135 | 48 |
| Comp. | Al—Zr | 15-150 | 40 | 7.2 | Yes | Yes | Yes | 21 | 70 | 100 | 75 |
| Ex. 2 | | | | | | | | | | | |

### EXAMPLE 4, COMPARATIVE EXAMPLE 3

In each example, an electrode sheet was obtained in the same manner as in Example 2, except that Al—Zr alloy powder with a particle diameter shown in Table 2 was used as Al—Zr alloy powder.

### EXAMPLE 5

In this example, an electrode sheet was obtained in the same manner as in Example 2, except that Al—Zr alloy (Al: 82 wt %, Zr: 18 wt %) powder was used as Al—Zr alloy powder.

TABLE 2

| | Alloy powder | | | | | | | | | | |
|---|---|---|---|---|---|---|---|---|---|---|---|
| | | | alpha | | | | | Porosity | | CV product | LC value |
| | | | phase | Spraying | | | | content rate | Heterogenous | index (when | Leakage |
| | | Particle | content | heat | Ultrasonic | Acid | | of sprayed | phase (Zr rich | Comparative | current |
| | | diameter | rate | quantity | cleaning | cleaning | Reduction | layer | layer) rate | Example 3 | amount |
| | Type | (μm) | (%) | (kJ/l) | treatment | treatment | treatment | (vol %) | (vol %) | is 100) | (μm) |
| Comp. | Al—Zr | 500-600 | 40 | 5 | Yes | Yes | Yes | 49 | 17 | 100 | 94 |
| Ex. 3 | | | | | | | | | | | |
| Ex. 4 | Al—Zr | 5-500 | 40 | 5 | Yes | Yes | Yes | 13 | 12 | 149 | 21 |
| Ex. 5 | Al—Zr | 15-150 | 40 | 5 | Yes | Yes | Yes | 3 | 12 | 178 | 27 |

### EXAMPLE 6

An electrode sheet was obtained in the same manner as in Example 2, except that ultrasonic cleaning step was omitted (ultrasonic cleaning step in acetone solution was omitted).

### EXAMPLE 7

An electrode sheet was obtained in the same manner as in Example 2, except that acid cleaning step and rolling step were omitted.

### EXAMPLE 8

An electrode sheet was obtained in the same manner as in Example 2, except that acid cleaning step was omitted (acid cleaning step for immersing the sheet for 3 minutes in 3-mass % nitric acid solution was omitted).

### EXAMPLE 9

An electrode sheet was obtained in the same manner as in Example 6, except that alkali cleaning step (alkali cleaning step for immersing the sheet for 3 minutes in 5-mass % sodium hydroxide solution) was performed in place of acid cleaning step.

### EXAMPLE 10

An electrode sheet was obtained in the same manner as in Example 2, except that ultrasonic cleaning step, acid cleaning step and rolling step were omitted.

TABLE 3

| | Alloy powder | | | | | | | | | | |
|---|---|---|---|---|---|---|---|---|---|---|---|
| | | | alpha | | | | | Porosity | | | LC value |
| | | | phase | Spraying | | | | content rate | Heterogenous | CV product | Amount of |
| | | Particle | content | heat | Ultrasonic | Acid | | of sprayed | phase (Zr rich | index (when | Leakage |
| | | diameter | rate | quantity | cleaning | cleaning | Reduction | layer | layer) rate | Example 10 | current |
| | Type | (μm) | (%) | (kJ/l) | treatment | treatment | treatment | (vol %) | (vol %) | is 100) | (μm) |
| Ex. 6 | Al—Zr | 15-150 | 40 | 5 | Nil | Yes | Yes | 7 | 18 | 135 | 28 |
| Ex. 7 | Al—Zr | 15-150 | 40 | 5 | Yes | Nil | Nil | 10 | 18 | 107 | 45 |
| Ex. 8 | Al—Zr | 15-150 | 40 | 5 | Yes | Nil | Yes | 7 | 18 | 124 | 32 |
| Ex. 9 | Al—Zr | 15-150 | 40 | 5 | Nil | * | Yes | 7 | 18 | 178 | 10 |
| Ex. 10 | Al—Zr | 15-150 | 40 | 5 | Nil | Nil | Nil | 10 | 18 | 100 | 75 |

*Alkali cleaning treatment was performed in place of acid cleaning treatment

The CV product and the amount of leakage current of each obtained electrode sheets were measured, and the porosity content rate of the sprayed layer was measured. The evaluation results are shown in Tables 1 to 3. As to the CV product (μFV/cm²), the relative value is shown in Table 1 when Comparative Example 2 is 100, in Table 2 when Comparative Example 3 is 100, and in Table 3 when Example 1 is 100.

<Measuring Method of CV Product and Measuring Method of Amount of Leakage Current>

These are measured in accordance with the EIAJ method.

<Measuring Method of Porosity Content Rate of Sprayed Layer>

The porosity content rate of the sprayed layer (non-rolled state) after the spraying was measured. The porosity content rate can be obtained by performing image analysis of the digital image of the composition image observed with the scanning electron microscope (SEM). Concretely, the porosity is shown as black points in a digital image, and therefore the area of the black points are calculated by the image analysis. Based on this calculated result, the porosity content rate (rate of content) can be obtained.

### INDUSTRIAL APPLICABILITY

The electrode sheet for capacitors according to the present invention can be used as an electrode for capacitors to be used in, e.g., personal computers or communication devices such as cellular phones. Among other things, it can be used as anode material for electrolytic capacitors.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A method of manufacturing an electrode sheet for capacitors, comprising the step of:
forming a sprayed layer of an Al-valve action metal alloy on at least one surface of an aluminum foil by thermally spraying Al-valve action metal alloy powder on the surface of the aluminum foil,
wherein a porosity content rate of the sprayed layer is controlled to 20 vol % or less by melting at least a matrix Al phase of the alloy at the time of the spraying.

2. A method of manufacturing an electrode sheet for capacitors, comprising the step of:
forming a sprayed layer of an Al-valve action metal alloy on at least one surface of an aluminum foil by thermally spraying Al-valve action metal alloy powder on the surface of the aluminum foil,
wherein a porosity content rate of the sprayed layer is controlled to 12 vol % or less by melting a matrix Al phase of the alloy with intermetallic compound of the Al-valve action metal which is high-melting point precipitate of the alloy unmelted at the time of the spraying.

3. A method of manufacturing an electrode sheet for capacitors, comprising the step of:
forming a sprayed layer of an Al-valve action metal alloy on at least one surface of an aluminum foil by thermally spraying Al-valve action metal alloy powder on the surface of the aluminum foil,
wherein the Al-valve action metal alloy powder is 5 to 500 μm in particle diameter, and wherein the spraying is performed with thermal spraying heat quantity set to 3 to 7 kJ/l.

4. The method of manufacturing an electrode sheet for capacitors as recited in claim 3, wherein the Al-valve action metal alloy powder is 5 to 95 vol % in alpha phase content rate.

5. The method of manufacturing an electrode sheet for capacitors as recited in any one of claims 1 to 3, wherein the aluminum foil is 8 to 200 μm in thickness.

6. The method of manufacturing an electrode sheet for capacitors as recited in any one of claims 1 to 3, further comprising the step of:
performing ultrasonic cleaning after the step of forming the sprayed layer of the Al-valve action metal alloy.

7. The method of manufacturing an electrode sheet for capacitors as recited in any one of claims 1 to 3, further comprising the step of:
performing rolling and annealing after the step of forming the sprayed layer of the Al-valve action metal alloy.

8. The method of manufacturing an electrode sheet for capacitors as recited in any one of claims 1 to 3, further comprising the step of:
performing acid cleaning or alkali cleaning after the step of forming the sprayed layer of the Al-valve action metal alloy.

9. The method of manufacturing an electrode sheet for capacitors as recited in any one of claims 1 to 3, wherein the Al-valve action metal alloy powder is alloy powder including one or more valve action metals selected from the group consisting of Ti, Zr, Nb, Ta and Hf, and Al.

10. The method of manufacturing an electrode sheet for capacitors as recited in any one of claims 1 to 3, wherein the Al-valve action metal alloy powder is Al—Zr alloy powder.

11. An electrode sheet for capacitors manufactured by the method as recited in any one of claims 1 to 3.

12. A method of manufacturing an anode material for electrolytic capacitors, comprising the steps of:
etching the electrode sheet for capacitors as recited in claim 11; and thereafter
executing a chemical conversion treatment to thereby form a dielectric film on a surface of the etched electrode sheet.

13. An anode material for electrolytic capacitors manufactured by the manufacturing method as recited in claim 12.

14. An electrolytic capacitor constituted by using the anode material as recited in claim 13.
